(19) United States
(12) Patent Application Publication
(10) Pub. No.: US 2009/0255880 A1
(43) Pub. Date: Oct. 15, 2009

(54) SINGLE USE SANITARY FILTER ASSEMBLY

(76) Inventors: Scott J. Pritchard, Chaska, MN (US); John V. Fullerton, III, Green Lane, PA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/423,510

(22) Filed: Apr. 14, 2009

Related U.S. Application Data
(60) Provisional application No. 61/044,749, filed on Apr. 14, 2008.

(51) Int. Cl. B01D 27/08; B01D 35/01; B29C 65/64

(52) U.S. Cl. 210/791; 210/232; 210/188; 210/238; 264/249

(57) ABSTRACT

A single use, disposable filtration assembly that eliminates the need for disassembly and replacement of fouled filtration modules in a pharmaceutical setting. The single use, disposable filtration assembly is a unitary assembly that is simply positioned and connected within the fluid processing system whereupon the disposable filtration assembly, upon reaching the end of its useable life, is removed from the process as a single, integral unit ready for disposal through appropriate methods.

### PRIORITY CLAIM

The present application claims priority to U.S. Provisional Application Ser. No. 61/044,749, filed Apr. 14, 2008, and entitled “SINGLE USE HOUSING FOR SANITARY DEPTH FILTER MODULES”, which is herein incorporated by reference in its entirety.

### FIELD OF THE INVENTION

The present invention relates to filtration products for sanitary filtering. More particularly, the present invention is directed to a pre-assembled, single use polymeric filter housing for use in filtering biotech/pharmaceutical fluids.

### BACKGROUND OF THE DISCLOSURE

As in many industries in which fluid processing is an integral portion of the business, the biotech/pharmaceutical industry has a variety of processing situations in which filters and filter housings are necessary either for filtering contaminants or in separating various solution components. While biotech/pharmaceutical filtering situations may share many of the same filtering technologies as other industries, the unique regulations governing biotech/pharmaceutical products and their production often require that biotech/pharmaceutical filtering products meet or satisfy stringent fabrication and handling requirements.

Generally, biotech/pharmaceutical processing requires the use of sanitary designs including suitable materials as well as the use of sanitary fittings/connectors. Typically, these sanitary designs utilize housings fabricated of stainless steel alloys that can tolerate exposure to harsh cleaning and sterilization conditions. While these designs generally work well during the actual filtration process, they can lead to a variety of issues when filter media enclosed within a sanitary housing becomes fouled and requires replacement with new filter media. In these situations, an often large, heavy and cumbersome filter housing must be fluidly disconnected from a fluid circuit and the filter housing disassembled to gain access to the fouled elements.

Not only does this require a substantial investment in the time and labor to accomplish replacement of the filters, it can lead to potential spillage of process fluids or exposure of the process to fouled filtration elements, either of which can negatively impact the sanitary environment in which the filtering process is occurring. Due to the potential negative impacts associated with the replacement of fouled filter elements in sanitary environments, it would be desirable to have a sanitary filtration system that is capable of eliminating the identified deficiencies.

### SUMMARY OF THE INVENTION

A single use, disposable filtration assembly of the present invention addresses and overcomes the identified deficiencies of prior art sanitary filtration assemblies by eliminating the need for disassembly and replacement of fouled filtration elements. Instead, the disposable filtration assembly of the present invention comprises a unitary assembly that is simply positioned and connected within the fluid processing system whereupon the disposable filtration assembly, upon reaching the end of its useable life, is removed from the process as a single, integral unit whereupon it can be disposed through appropriate methods. A new, ready to use disposable filtration assembly can then positioned and attached for use without exposing the processing environment to the fouled filtration elements of the prior filtration assembly.

In one aspect of the present invention, a single use disposable filtration assembly comprises an upper housing and a lower plate that are essentially permanently joined to enclose one or more filter modules. The upper housing and lower plate are fabricated from polymeric materials suited for use in sanitary conditions and that are readily disposed of in conventional waste streams. Following a period of filtration of an incoming fluid, a now spent and fouled, single use disposable filtration assembly can be replaced simply by draining and detaching the spent disposable filtration assembly and replacing the spent assembly with a new single use disposable filtration assembly.

In another aspect of the present invention, a biotech/pharmaceutical filtration system comprises a single use disposable filtration assembly. The single use disposable filtration assembly can comprise an upper housing and a lower plate that are operably, sealingly coupled so as to permanently encloses and capture one or more filter modules. Generally, the single use disposable filtration assembly can be disposed of as an integral unit when fouled such that a new single use disposable filtration assembly can be positioned for further processing.

In another aspect of the present invention, a method of forming a single use disposable filtration assembly can comprise mounting one or more filter modules to a lower plate. The method can further comprise positioning an upper housing over the filter modules and sealingly coupling the upper housing to the lower plate to form the single use disposable filtration assembly. The method can further comprise positioning the single use disposable filtration assembly in a process for filtration of a fluid. The method can further comprise disposing of the single use disposable filtration assembly once a useful life of the one or more filter modules is ended. The method can further comprise replacing a spent single use disposable filtration assembly with a new single use disposable filtration assembly.

In another aspect of the present invention, a method for preventing exposure of filtration waste during a filter replacement can comprise providing a single use disposable filtration assembly that is completely disposed of without accessing contaminated depth filters. The method can further comprise positioning a new single use disposable filtration assembly within a filtering process to comment further filtration processes.

The above summary of the various aspects of the disclosure is not intended to describe each illustrated embodiment or every implementation of the invention. The figures in the detailed description that follow more particularly exemplify these embodiments.

### BRIEF DESCRIPTION OF THE FIGURES

The embodiments of the present invention may be more completely understood in consideration of the following detailed description of various embodiments in connection with the accompanying drawings, in which:

FIG. 1 is a perspective view of a single use, disposable filter housing according to an embodiment of the present invention.

FIG. 1A is a perspective, section view of the single use, disposable filter housing of FIG. 1 taken at line A-A of FIG. 1.

FIG. 2 is a side view of the single use, disposable filter housing of FIG. 1.

FIG. 2A is a section view of the single use, disposable filter housing of FIG. 1 taken at line A-A of FIG. 2.

FIG. 2B is a section view of the single use, disposable filter housing of FIG. 1 taken at line B-B of FIG. 2.

FIG. 3 is a side view of the single use, disposable filter housing of FIG. 1.

FIG. 3A is a section view of the single use, disposable filter housing of FIG. 1 taken at line A-A of FIG. 3.

FIG. 3B is a section view of the single use, disposable filter housing of FIG. 1 taken at line B-B of FIG. 3.

FIG. 4 is a top view of the single use, disposable filter housing of FIG. 1.

FIG. 5 is a bottom view of the single use, disposable filter housing of FIG. 1.

FIG. 6 is a perspective view of a sealing disc according to an embodiment of the present invention.

FIG. 7 is a perspective section view of the sealing disc of FIG. 6 utilized in the single use, disposable filter housing of FIG. 1.

FIG. 8 is a perspective view of a sealing disc according to an embodiment of the present invention.

FIG. 9 is a perspective section view of the sealing disc of FIG. 8 utilized in the single use, disposable filter housing of FIG. 1.

FIG. 10 is a perspective view of the single use, disposable filter housing of FIG. 1 retainably positioned on a support stand according to an embodiment of the present invention.

FIG. 11 is a side view of the single use, disposable filter housing retainably positioned on the support stand of FIG. 10.

FIG. 12 is a section view of the single use, disposable filter housing retainably positioned on the support stand of FIG. 10.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE FIGURES

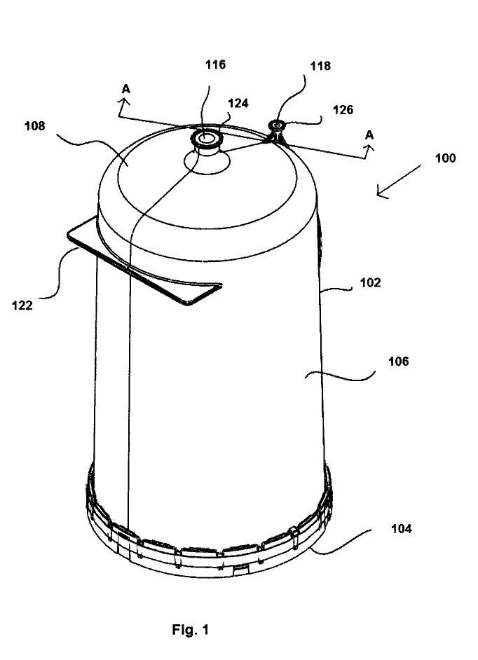

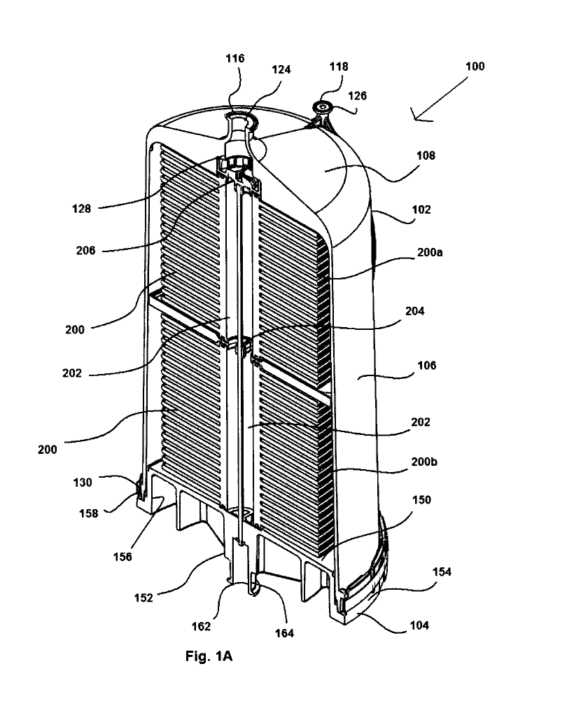

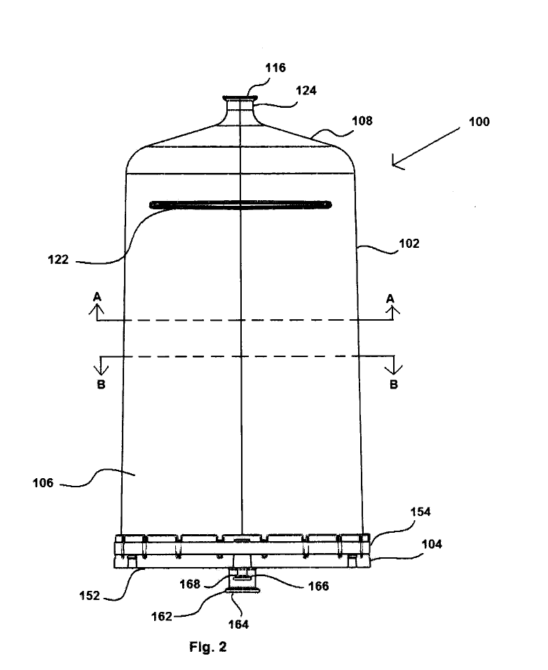

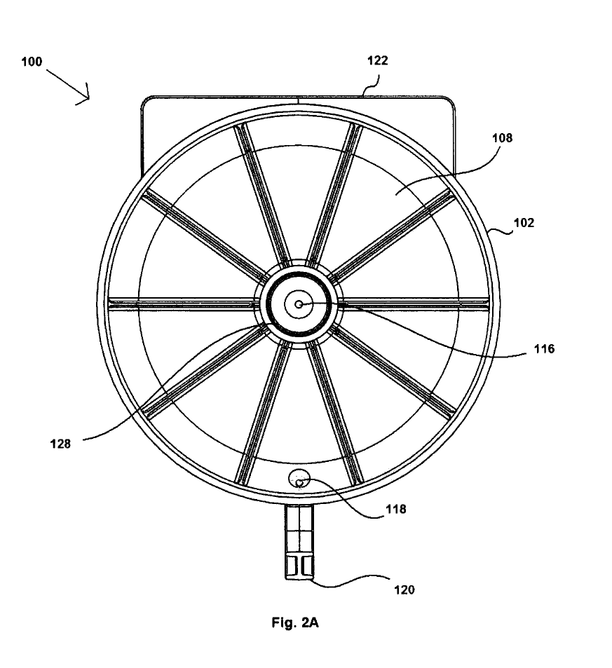

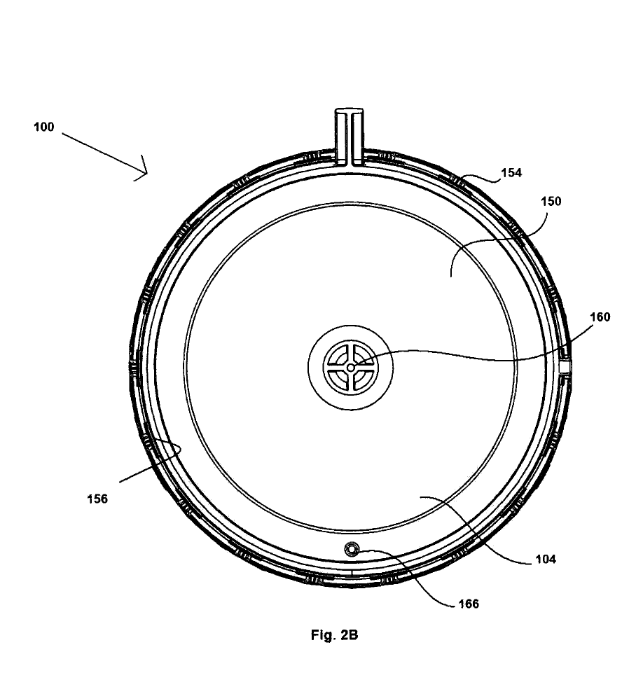

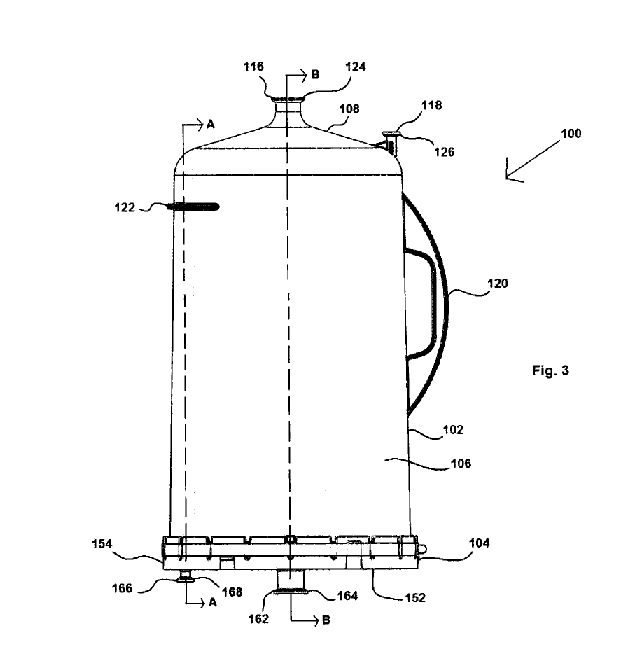

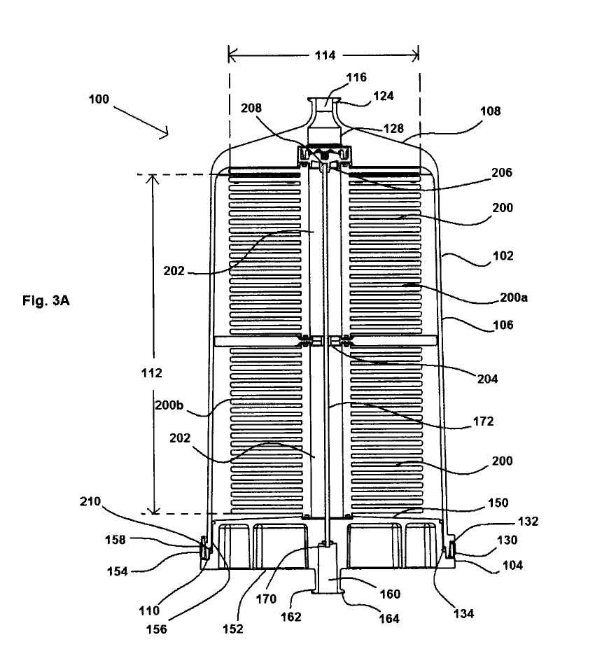

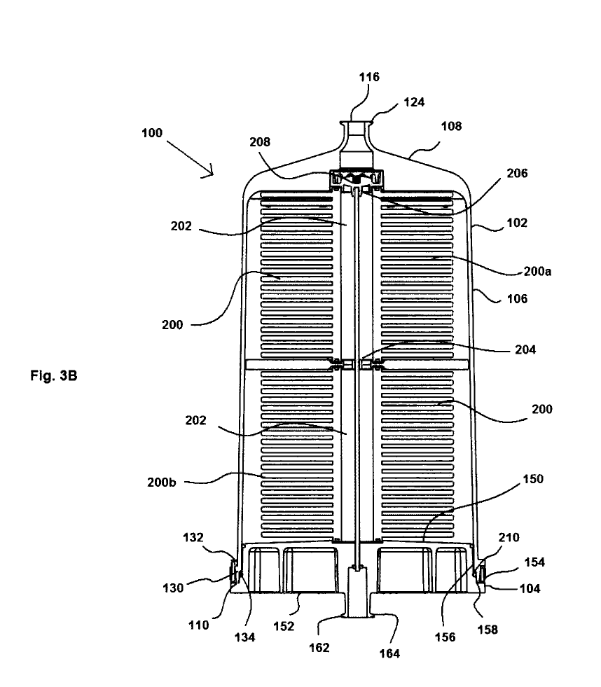

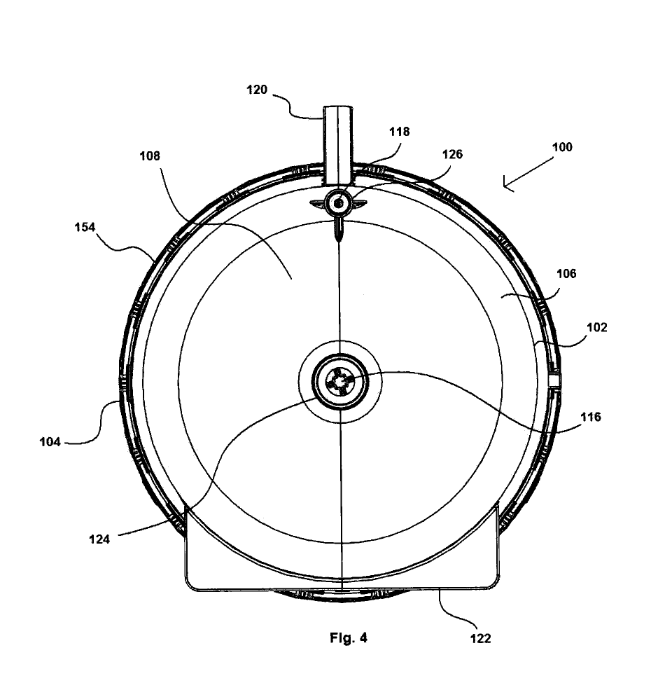

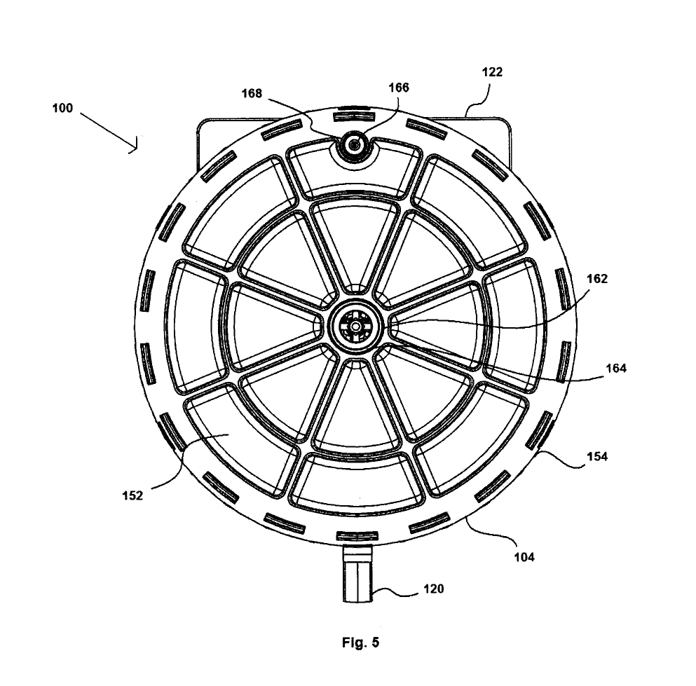

Referring now to FIGS. 1-5, a single use, disposable filter housing 100 of the present invention can comprise an upper housing 102 and a lower plate 104. Upper housing 102 and lower plate 104 generally comprise molded components fabricated from suitable polymeric materials. In some embodiments, upper housing 102 and lower plate 104 can be molded from polymers such as, for example, polyethylene and polypropylene, though it will be understood that a variety of alternative polymers can be suitably utilized based on compatibility factors such as temperature or chemical compatibility. Suitable polymeric materials will satisfy USP Class VI requirements and in some representative embodiments, can be compatible with gamma-irradiation processes.

Upper housing 102 generally comprise a cylindrical body 106 having an upper closed end 108 and a lower open end 110. Cylindrical body 106 generally defines a stack height 112 and a body diameter 114. Stack height 112 and body diameter 114 can vary dependent upon the desired flow capacity of disposable filter housing 100 by, for example, increasing the number of stacked filter elements or by increasing the diameter of the filter element to increase available an available filter area. Conventional dimensions for cylindrical body 106 can include stack heights 112 ranging from about 16″ to about 54″. Upper housing 102 further defines a variety of external feature including, for example, a flow inlet 116, a vent port 118, one or more handles 120 and a support member 122. Flow inlet 116 generally defines a sanitary inlet coupling 124 while vent port 118 defines a sanitary vent coupling 126. Sanitary inlet coupling 124 can comprise suitable dimensions such as, for example, 1.0″ or 1.5″ inch connections. Sanitary inlet coupling 124 and sanitary vent coupling 126 can comprise suitable sanitary configurations such as, for example, tri-clamp style sanitary fittings for joining to suitable configured connections on process piping members. Sanitary inlet coupling 124 further defines an internal filter interface 128. Cylindrical body 106 further comprises an offset ring 130 proximate the lower open end 110. Offset ring 130 generally defines an upper flanged surface 132 and a lower flanged surface 134.

Lower plate 104 generally comprises an inner filter engagement surface 150, an exterior bottom surface 152 and a perimeter support surface 154. A perimeter inner plate wall 156 is generally defined at the perimeter of the inner filter engagement surface 150. Perimeter support surface 154 and perimeter inner plate wall 156 generally define a flanged receiving channel 158 configured and sized to as to receive insertion of the offset ring 130. Lower plate 104 generally defines an outlet flow channel 160 fluidly interconnecting the inner filter engagement surface 150 with the exterior bottom surface 152. At the exterior bottom surface 152, the outlet flow channel 160 operably defines a flow outlet 162 having a sanitary outlet coupling 164. Sanitary outlet coupling 164 preferably resembles the configuration of sanitary inlet coupling 124 and can have a similar connection diameter of 1.0″ or 1.5″. Lower plate 104 can further comprise a drain flow channel 166 fluidly interconnecting the inner filter engagement surface 150 with the exterior bottom surface 152. Drain flow channel 166 generally includes a sanitary drain coupling 168. Inner filter engagement surface 150 generally comprises one or more mounting apertures 170 arranged about the outlet flow channel 160. Assembly rod 172 can be attached in each mounting aperture 170 using suitable attachment methods, such as, for example, threaded attachment, adhesive attachment or various molding attachment methods.

In use, disposable filter housing 100 will generally be fully assembled and packaged for immediate installation into a desired filtering process. Disposable filter housing 100 can be utilized in a variety of filtration applications including, for example, clarification processes, catalyst capture and removal processes, both pre and final filtration processes, additive absorption, removal and capture processes and diatomite capture and septum processes. At a point of packaging, one or more filter modules 200 will be added to and integrally sealed within the disposable filter housing 100. Filter modules 200 can comprise any variety of suitable filter elements including, for example, commercially available encapsulated depth filter modules manufactured by companies including, for example, Millipore, Pall, Cuno, Sartorius-Stedim, GE, Purolator, Begerow and Ertel Alsop. Generally, filter modules 200 perform the filtering function by having a fluid to be filtered enter the filter media from an exterior, exposed portion of the filter media such that contaminants including, for example, particulate and biological matter are physically entrained within the filter media.

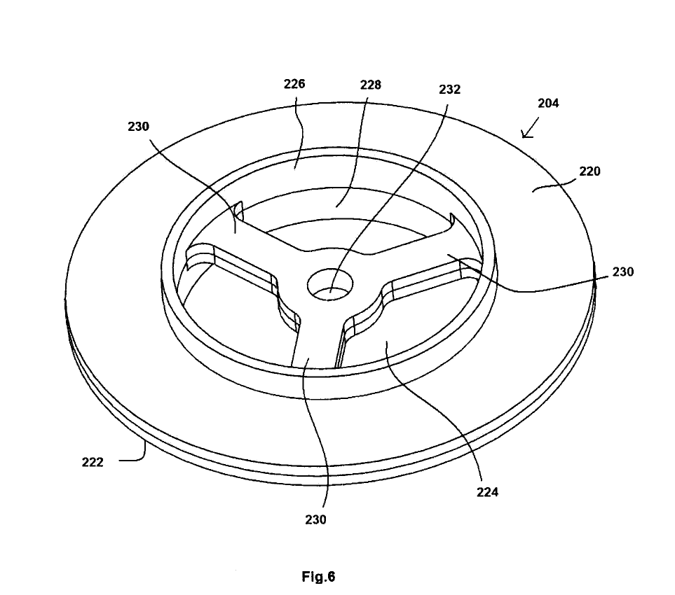

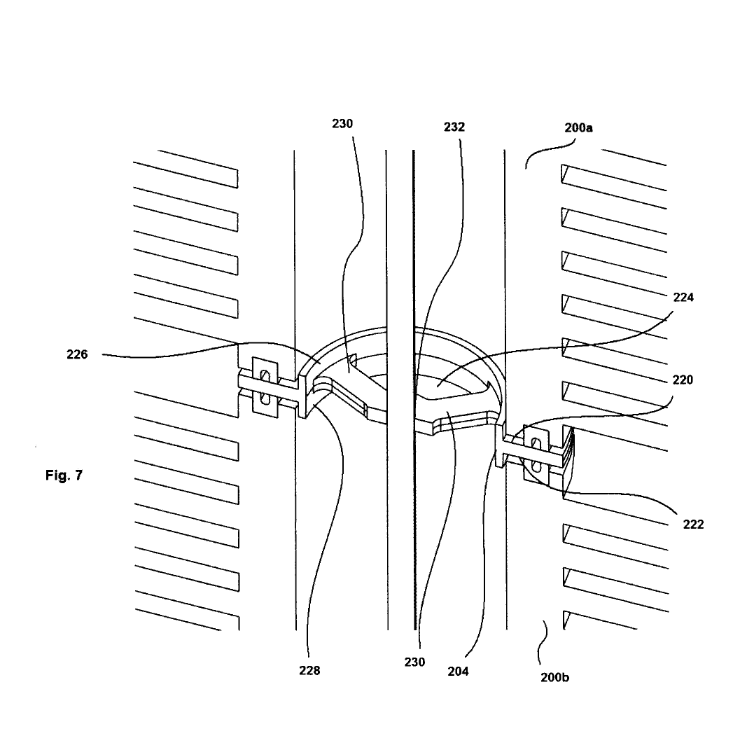

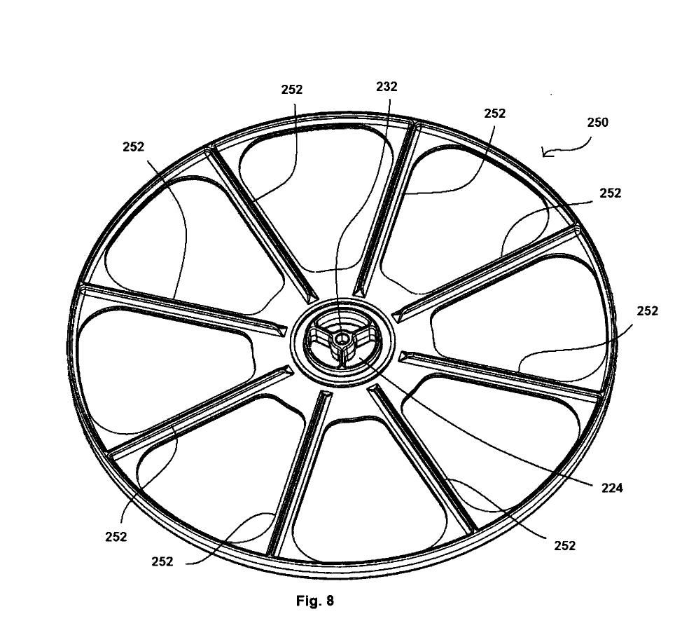

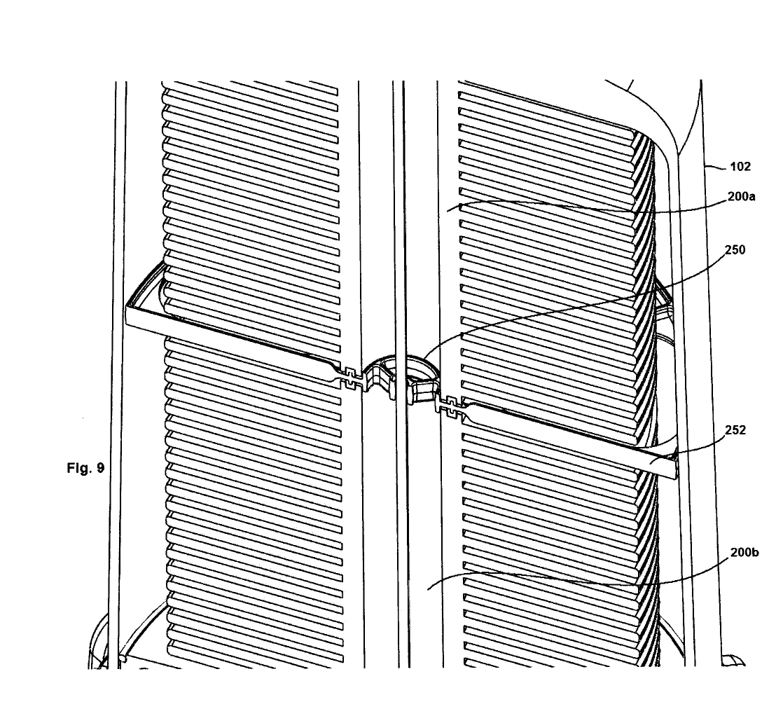

To install the one or more filter modules 200, each filter module is arranged such that a central filtered water channel 202 is placed over assembly rod 172 on lower plate 104. The one or more filter modules 200 are then dropped over the assembly rods 172 such that a bottommost filter module 200 resides against the inner filter engagement surface 150. In the event that multiple filter modules 200 are utilized such as, for example, an upper filter module 200a and a lower filter module 200b, a sealing disc 204 as shown in FIGS. 6 and 7 can be utilized to engage and seal the central filtered fluid channels 202 so as to prevent contamination between the upper and lower filter modules 200a, 200b. Sealing disc 204 generally comprises an upper sealing surface 220 for sealingly engaging a bottom portion of the upper filter module 200a and a lower sealing surface 222 for sealingly engaging an upper portion of the lower filter module 200b. Sealing disc 204 includes a central bore 224 defined by an upper projecting wall 226 and a lower projecting wall 228. A plurality of support ribs 230 extend into the central bore 224 to define an alignment aperture 232 sized for placement over the assembly rod 172. Sealing disc 204 is generally fabricated of a polymeric material distinct from the seals on the central filtered fluid channel 202 so as to provide for formation of a fluid-tight ID alignment of the central filtered fluid channels 202 on the one or more filter modules 200. Depending upon the size and loading requirements of the upper and lower filter modules 200a, 200b, an alternative embodiment of a sealing disk 250 can be utilized in which a plurality of support ribs 252 extend outward such that a disk perimeter wall 252 is in contact an inner surface of the upper housing 102 as shown in FIGS. 8 and 9. In this manner, sealing disk 150 offers support across an entire width of the upper and lower filter modules 200a, 200b such any sagging or twisting of the upper and lower filter modules 200a, 200b does not negatively impact sealing of the central filtered fluid channel 202.

With the one or more filter modules 200 positioned on the lower plate 104, an inlet disc 206 is mounted over the assembly rod 172 and retained with an inlet fastener 208. Inlet disc 206 comprises a substantially solid disc having a single aperture for receiving the assembly rod 172. Coupling inlet disc 206 over the central filtered fluid channel 202 accomplishes the dual purpose of coupling the one or more filter modules 200 to the lower plate 104, while simultaneously providing a barrier to unfiltered fluid entering the central filtered fluid channel 202 as unfiltered fluid enters the upper housing 102 through the internal filter interface 128.

Depending upon the desired filtering rate, an assembler stacks the one or more filter modules 200 so as to provide for enough filter media to accomplish the filtration according to the filter manufacturers operational specifications. In some filtering situations, it may be beneficial to utilize a plurality of single use disposable filter housings 100 plumbed in parallel based on factors such as flow rate or for redundancy in critical filtration situations where filtration downtime is unacceptable.

With the one or more filter modules 200 positioned and retained on lower plate 104, upper housing 102 is oriented so as to drop the lower open end 110 over the filter modules 200. As lower open end 110 approaches the lower plate 104, a variety of engagement and sealing interactions occur almost simultaneously. As lower open end 110 approaches lower plate 104, cylindrical body 106 and more specifically offset ring 130 is guided into receiving channel 158. Prior to guiding the offset ring 130 into the receiving channel 158, one or more sealing members 210 such as, for example, a polymeric o-ring, can be positioned within receiving channel 158. As the offset ring 130 reaches the bottom of receiving channel 158, upper and lower flanged surfaces 132, 134 interact with the receiving channel 158 such that removal of the upper housing 102 from the lower plate 104 is prevented while a fluid-tight seal is formed at the engagement of the sealing member 210, the offset ring 130 and the receiving channel 158.

Generally, disposable filter housing 100 is placed into use by attaching the sanitary inlet coupling 124 to a corresponding coupling on an inlet fluid line, attaching the sanitary vent coupling 126 to a corresponding coupling on a vent line, attaching the sanitary outlet coupling 164 to a corresponding coupling on an outlet fluid line and attaching the sanitary drain coupling 168 to a corresponding coupling a drain fluid line. With the disposable filter housing 100 fluidly connected into the process, an inlet valve on the inlet fluid line as well as a vent valve on the vent line can both be opened. As the disposable filter housing 100 fills with fluid, air from within the disposable filter housing 100 is exhausted through vent port 118. Once the disposable filter housing 100 is filled with fluid, an outlet valve in the outlet fluid line can be opened such flow through the disposable filter housing is commenced. Generally, the fluid to be filtered enters through the flow inlet 116 and contacts the inlet disc 206 wherein the fluid is directed to the exterior/outer wall of the cylindrical body 106. The fluid to be filtered enters the one or more filter modules 200 and travels through the filter media wherein contaminants are retained in filtration media and a now filtered fluid enters the central filtered fluid channel. The now filtered fluid exits the central filtered fluid channel through the outlet flow channel 160 wherein the filtered fluid is directed for use or further processing through the outlet fluid line. In typical situations, single use disposable filter housing 100 will be subject to working pressures of 15-28 psi with a maximum 40 psi working pressure.

Based on factors such as, for example, measured pressured drop across the disposable filter housing 100, volumetric throughput or on a calendar basis, disposable filter housing 100 is replaced simply by closing the inlet valve on the inlet flow line, the outlet valve on the outlet flow line and by opening a drain valve in the drain line. Any fluid within the disposable filter housing 100 is evacuated through the drain flow channel 166 for disposal or recovery depending upon the fluid be filtered. Once drained, the disposable filter housing 100 is removed simply by detaching the connections at the sanitary inlet coupling 124, sanitary vent coupling 126, sanitary outlet coupling 164 and sanitary drain coupling 168. The disposable filter housing 100 is then disposed of as a single integral unit while a new disposable filter housing 100 is attached in position as previously described. In this manner, the time, labor and potential messy replacement of spent filter media is reduced as compared to conventional filtration systems in which a filter housing must be disassembled and filtration elements individually mounted in position. In addition, use of disposable filter housing 100 avoids exposing personnel to potentially unsafe or hazardous material removed and retained within the filtration elements during filtering. While described as being especially applicable to pharmaceutical and biochemical filtering applications, the advantages of avoiding exposure to personnel during filter changes while reducing process downtime can apply to a variety of other industries including fine and special chemical production, food and beverage production as well as industrial filtration applications.

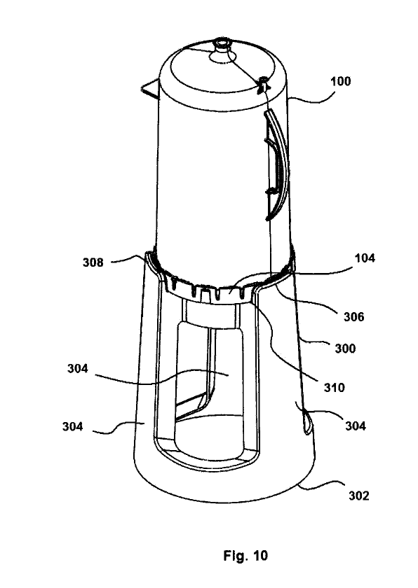

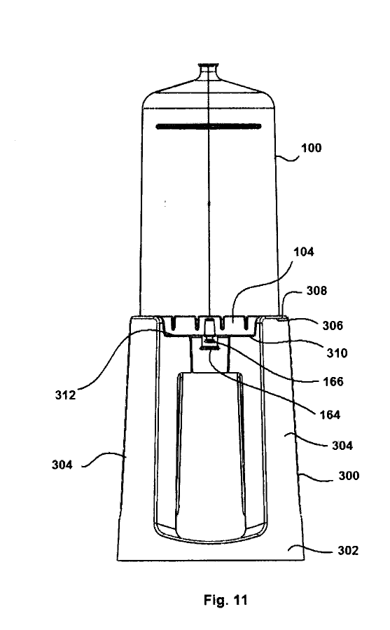

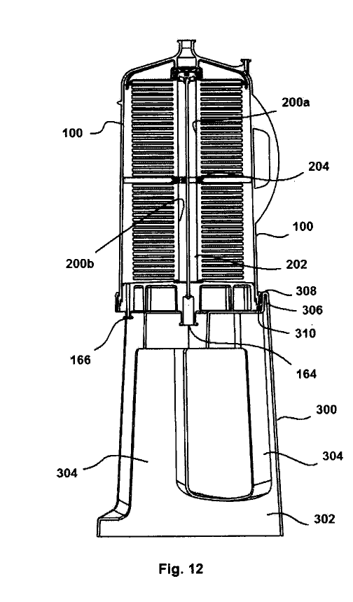

In some process environments, it may be advantageous to place and position disposable filter housing 100 on a support stand 300 as illustrated in FIGS. 10, 11 and 12. Support stand 300 is generally constructed of materials suitable for sanitary processing conditions such as, for example, stainless steel or suitable polymeric materials such as, for example, high density polyethylene. Generally, support stand 300 includes a base portion 302, a plurality of support legs 304 and a mounting portion 306. Mounting portion 306 is generally defined by a raised lip 308, a recessed surface 310 and a central opening 312. Mounting portion 306 is dimensioned such that a mounting diameter defined by the raised lip 308 slightly exceeds the diameter of the lower plate 104. In this manner, disposable filter housing 100 can be lifted and set onto the recessed surface 310 such that raised lip 308 captures and prevents movement of the disposable filter housing 100, while the sanitary outlet coupling 164 and drain flow channel 166 extend through the central opening 312. Mounting portion 306 can include a cut-way section 312 so as to provide access for the connection of process lines to the sanitary outlet coupling 164 and drain flow channel 166, while the disposable filter housing 100 is retainably mounted on the support stand 300.

It will thus be seen according to the present invention a single use, disposable filtration system for pharmaceutical application and associated methods of use have been disclosed. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A sanitary, disposable filter assembly, comprising:
a polymeric filter housing including an upper housing and a lower plate, the upper housing defining a lower open end, the lower plate having a circumferential receiving channel and a filter engagement surface, and
at least one filter module,
wherein the circumferential receiving channel is adapted to sealing, receive the lower open end so as to permanently couple the upper housing to the lower plate such that the at least one filter module is engaged by the filter engagement surface with the at least one filter module enclosed within the polymeric filter housing.

2. The filter assembly of claim 1, wherein the lower plate includes at least one circumferential sealing member positioned within the circumferential receiving channel, the at least one circumferential sealing member engaging a housing wall to sealingly couple the upper housing to the lower plate.

3. The filter assembly of claim 1, wherein the upper housing comprises a sanitary inlet coupling for introducing process fluids into the polymeric filter housing.

4. The filter assembly of claim 3, wherein the upper housing comprises a sanitary vent coupling for venting gases trapped within the polymeric filter housing as the process fluid is introduced through the sanitary inlet coupling.

5. The filter assembly of claim 1, wherein the upper housing comprises a handle assembly for positioning the polymeric filter housing.

6. The filter assembly of claim 1, wherein the upper housing comprises a support member preventing movement of the filter module within the polymeric filter housing.

7. The filter assembly of claim 1, wherein the lower plate comprises an outlet fluid valve for selectively directing a filtered process fluid from the polymeric filter housing.

8. The filter assembly of claim 1, wherein the lower plate comprises a sanitary drain coupling for selectively draining fluid from the polymeric filter housing.

9. The filter assembly of claim 1, further comprising:
a support stand engaging the lower plate to elevate and support the polymeric filter housing, the support stand providing access to the lower plate such that one or more sanitary outlet connections on the lower plate can be fluidly connected to process lines while the polymeric filter housing is positioned on the support stand.

10. The filter assembly of claim 1, wherein the upper housing and lower plate are molded from a polymer satisfying USP Class VI requirements.

11. The filter assembly of claim 1, wherein the at least one filter module, comprises an upper filter module and a lower filter module arranged in a stacked configuration, the upper filter module sealingly engaging the upper housing and the lower filter module sealingly engaging the lower plate.

12. The filter assembly of claim 11, further comprising at least one sealing disc having an upper sealing surface and a lower sealing surface, wherein the upper sealing surface sealingly engages the upper filter module and the lower sealing surface engages the lower filter module to prevent an unfiltered process fluid from entering a central filtered fluid channel of both the upper filter module and the lower filter.

13. A method of filtering a process fluid with the sanitary, disposable filter assembly of claim 1.

14. The method of claim 13, further comprising:
exhausting a filtering capacity of the at least one filter module; and
replacing the sanitary, disposable filter assembly with a second, sanitary disposable filter assembly that is structurally equivalent to the sanitary, disposable filter assembly.

15. The method of claim 14, further comprising:
disposing of the sanitary, disposable filter assembly as an integral unit.

16. A method of fabricating a sanitary, single use disposable filtration assembly comprising:
molding an upper housing and a lower plate from a polymer satisfying USP Class VI requirements;
providing at least one filter module;
mounting the at least one filter module to the lower plate such that a central filtered portion of the at least one filter module sealingly engages a sanitary fluid outlet on the lower plate;
inserting a lower open end of the upper housing into a circumferential receiving channel on the lower plate to form a fluid tight seal between the upper housing and the lower plate and wherein the central filtered fluid channel of the at least one filter module sealingly engages the upper housing.

17. The method of claim 16, wherein providing the at least one filter module, comprises providing an upper filter module and a lower filter module arranged in a stacked configuration, the upper filter module sealingly engaging the upper housing and the lower filter module sealingly engaging the lower plate.

18. The method of claim 17, further comprising:
providing at least one sealing disc between the upper filter module and the lower filter module, the at least one sealing disc having an upper sealing surface and a lower sealing surface, wherein the upper sealing surface sealing engages the upper filter module and the lower sealing surface engages the lower filter module to prevent an unfiltered process fluid from entering the central filtered fluid channel of both the upper filter module and the lower filter module.

19. The method of claim 16, wherein inserting the lower open end of the upper housing into the circumferential receiving channel on the lower plate to form the fluid tight seal, further comprises:
positioning a sealing member within the circumferential receiving channel; and
compressing the sealing member between the upper housing and the lower plate.

20. The method of claim 19, wherein inserting the lower open end of the upper housing into the circumferential receiving channel on the lower plate to form the fluid tight seal, further comprises:
locking the upper housing to the lower plate by capturing an offset ring at the lower open end within a flanged circumferential receiving channel.
